(19) United States
(12) Patent Application Publication
(10) Pub. No.: US 2009/0260251 A1
(43) Pub. Date: Oct. 22, 2009

(54) Clothes dryer with louvre cover

(75) Inventors: Silvia Ionelia Prajescu, Dollard Des Ormeaux (CA); Pasquale Antonio Renzo, Anjou (CA); Dominique Larochelle, St-Bruno (CA)

Correspondence Address: CRAIG WILSON, 2570 MATHESON BLVD. EAST, SUITE 211, MISSISSAUGA, ON, L4W 4Z3, CA

(73) Assignee: MABE CANADA INC., Burlington (CA)

(21) Appl. No.: 12/232,211

(22) Filed: Sep. 12, 2008

(30) Foreign Application Priority Data
Apr. 18, 2008 (CA) 2,629,493

(51) Int. Cl. F26B 25/06

(52) U.S. Cl. 34/235

(57) ABSTRACT

A clothes dryer has horizontally extending louvres located in its rear cabinet wall that permit ambient air to enter the dryer cabinet during normal dryer operation. U-shaped cover brackets are positioned to horizontally extend and cover the louvres where the brackets each define a horizontally extending airflow channel having opposing open ends. Air entering the dryer flows through the louvres along the airflow channels and out through the open ends. The cover bracket helps to contain a fire within the dryer cabinet should one occur by restricting flow of ignited particles and other debris as a result of a fire from exiting through the louvre.

### FIELD OF THE INVENTION

The present invention relates to a clothes dryer and, more particularly, relates to one or more covers placed over air entry louvres to restrict the flow of ignited particles, and other debris as a result of a fire, from escaping from the dyer through the louvres should a fire develop in the dryer cabinet.

### BACKGROUND OF THE INVENTION

In a clothes dryer air is typically circulated across clothing contained in a rotating dryer drum. The air is heated prior to entry into the drum by means of electrically energized heating elements or by a gas burner contained in a heating assembly. Air is either drawn, or blown, through the drum by a fan that moves the air out of the drum across a lint filter and through exhaust venting out of the dryer. Typically, the rear wall of the dryer is provided with louvres comprising horizontal extending openings having fixed sloping fins that allow ambient air to enter the dryer cabinet and pass through the heater assembly. The ambient air is drawn through the louvres into the cabinet due to the negative pressure created in the dryer cabinet by the air moving out of the cabinet via the exhaust venting.

When the dryer is subjected to recent and more stringent fire testing, sparks of ignited particles of cheese cloth, representing dust or lint, rise and fall within the dryer cabinet and in some instances escape from the dryer cabinet through the louvre. Accordingly, there is a need to develop an air flow entry for a dryer that permits ambient air to flow into the dryer during normal dryer operation and restricts the flow of ignited particles and other debris escaping from the dryer cabinet so as to help contain a fire in the cabinet should one develop.

### BRIEF DESCRIPTION OF THE INVENTION

The present invention relates to a clothes dryer and, more particularly, relates to one or more covers placed over air entry louvres to restrict the flow of ignited particles and other debris from escaping from the dyer through the louvres should a fire develop in the dryer cabinet.

In accordance with one embodiment of the present invention, a clothes dryer comprises a cabinet having a wall and a louvre located in the wall to allow ambient air to enter the cabinet. The clothes dryer comprises a cover mounted inside the cabinet and mounted to the wall. The cover extends over the louvre to define an air flow channel that permits air to flow into the cabinet through the louvre and along the air flow channel while restricting flow of ignited particles and debris from exiting through the louvre.

In accordance with another embodiment, the cover overlays the louvre and is spaced therefrom. The cover extends along the louvre to define an air flow channel between the cover and the wall where the airflow channel has an at least one opening between the wall and an end portion of the cover to permit air to flow into the cabinet through the louvre, along the air flow channel and out the at least one opening while restricting flow of ignited particles and debris from exiting through the louvre.

By having the cover spaced from the louvre, an airflow channel is defined between the cover and rear wall that extends along the length of the louvre. While this airflow channel forms a restriction to air flowing into the dryer cabinet, this restriction is inconsequential due to the negative pressure induced in the dryer during dryer operation by the blower fan. The blower fan draws ambient air in through the louvre and along the airflow channel into the dryer cabinet space while at the same time pushing heated air from the dryer drum out the dryer exhaust vent. The advantage associated with the use of the cover is that it helps to contain a fire within the dryer should one occur. Any particles which are ignited in the dryer, or other debris as a result of a fire, have a tendency to rise and fall within the dryer cabinet. The cover extending over the louvres restrict flow of rising and falling particles from exiting directly out of the louvre without having to first enter into the airflow channel.

It should be understood that one or more covers preferably extends at least along the entire length of the louvre to form the air flow channel along the length of the louvre and perhaps beyond. This air flow channel is open at the ends of the cover to permit air flow into the dryer.

In an embodiment of the present invention a plurality of louvres are located in a rear wall of the cabinet. Each louvre has a cover that defines an airflow channel extending along the corresponding louvre.

In one embodiment the cover may comprise a bracket that has side walls that extend from the wall of the cabinet to form the airflow channel. In a preferred embodiment the cover has an additional end wall so that it has a u-shaped configuration where the end wall extends between the side walls of the bracket. The side walls further each comprise a flange that lies flush with and may be mounted to the wall of the cabinet. The cover bracket has opposing open ends through which air entering through the louvre moves along the air flow channel and passes through the open ends into the cabinet. It should be understood that while the preferred embodiment is directed to a bracket having a square u-shaped cross-sectional configuration, alternative suitable shapes may be employed such as, for example, a triangular V-shaped cross-sectional shape, a rounded u-shaped cross-sectional shape, or a semi-circular cross-sectional shape. Each of these embodiments provides the airflow channel that extends along the length of the louvre.

### BRIEF DESCRIPTION OF THE DRAWINGS

For a more thorough understanding of the nature and objects of the present invention reference may be had, by way of example, to the accompanying diagrammatic drawings in which:

FIG. 1 is a perspective view of an exemplary clothes dryer that may benefit from the present invention;

FIG. 2 is a side sectional view of an exemplary clothes dryer that may benefit from the present invention;

FIG. 3 is an interior perspective of the exemplary clothes dryer showing the rear wall of the clothes dryer cabinet with most of the internal components removed;

FIG. 4 is a closer perspective view of the rear wall of the dryer cabinet from inside the dryer cabinet;

FIG. 5 is an enlarged partial perspective sectional view of the covers of the present invention; and,

FIGS. 6A, to 6C show cross-sectional shapes of alternative embodiments for the cover.

### DETAILED DESCRIPTION OF THE INVENTION

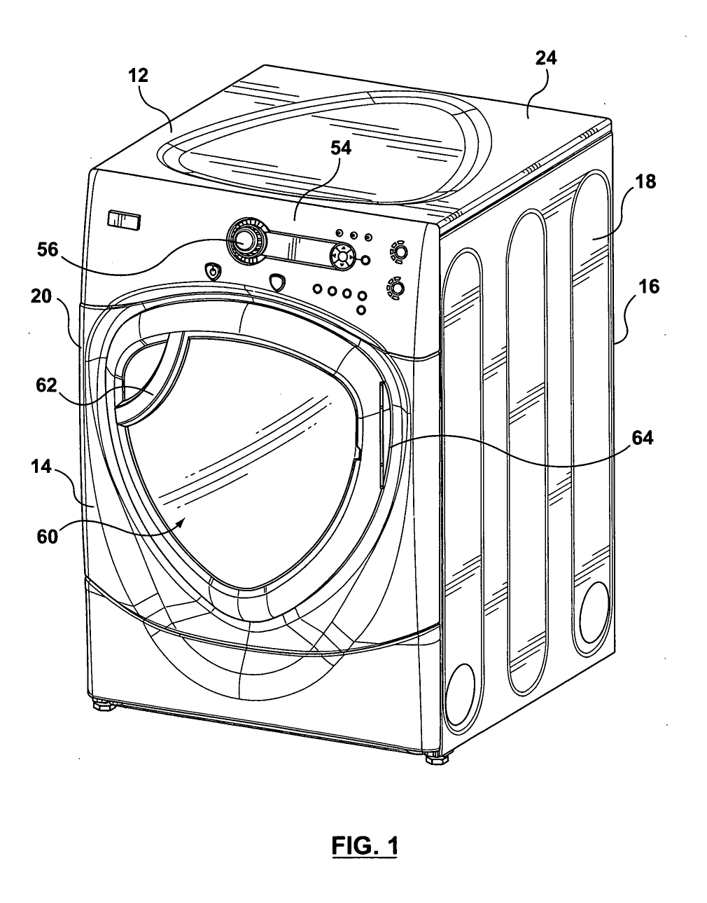

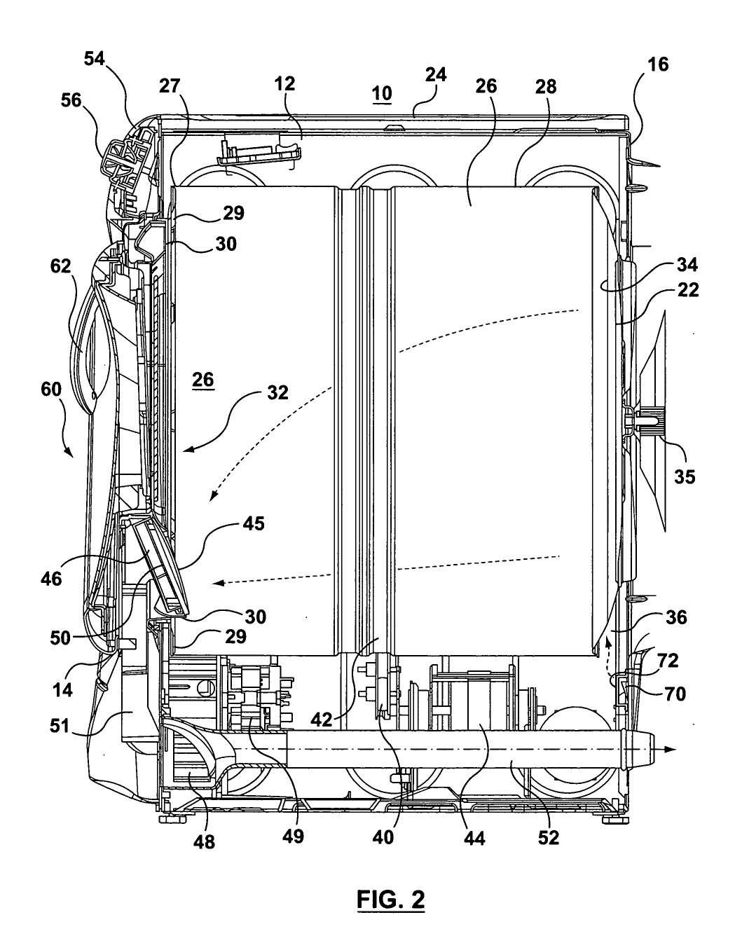

FIGS. 1 and 2 show perspective and side sectional views of an exemplary clothes dryer 10 that may benefit from the present invention. The clothes dryer 10 includes a cabinet or a main housing 12 having a front wall 14, a rear wall 16, a pair of side walls 18 and 20 spaced apart from each other by the front and rear walls, and a top cover 24. Within the housing 12 is a drum or container 26 mounted for rotation around a substantially horizontal axis. A motor 44 rotates the drum 26 about the horizontal axis through, for example, a pulley 40 and a belt 42. The drum 26 is generally cylindrical in shape, has an outer cylindrical wall 28, and has an open end 27 that typically comprises a metal ring 29 attached by welding to the drum 26 for reducing the diameter of the opening of the drum 26 to match a front bulkhead wall or front bearing 30. The bearing 30 further defines an opening 32 into the drum 26. Clothing articles and other fabrics are loaded into the drum 26 through the opening 32. A plurality of tumbling ribs (not shown) are provided within the drum 26 to lift the articles and then allow them to tumble back to the bottom of the drum as the drum rotates. The drum 26 includes a rear wall 34 rotatably supported within the main housing 12 by bearing 35. The rear wall 34 includes a plurality of holes (not shown) that receive hot air that has been heated by a heater such as electrical heating elements (not shown) in the heater housing 22. The heater housing 22 receives ambient air via an inlet 36. Although the exemplary clothes dryer 10 shown in FIG. 1 is an electric dryer, it could just as well be a gas dryer having a gas burner.

Heated air is drawn from the drum 26 by a blower fan 48 which is also driven by a second motor 49 in the embodiment shown. In an alternative embodiment, motor 44 could be used to drive blower fan 48. The air passes through a grill 45 and screen filter 46. Grill 45 keeps clothing articles tumbling in the drum 26 from contacting the filter 46 and touching the lint trapped by the filter 46 within the trap duct 50. As the air passes through the screen filter 46, it flows through lower duct portion 51 and is drawn by blower fan 48 attached to motor 49 out of the clothes dryer through an exhaust duct 52. In this embodiment, the drum 26 is in air flow communication with the trap duct 50 whose lower duct portion 51 has an outlet that is in air flow communication with the blower fan 48 and the exhaust duct 52. The exhaust duct 52 passes through the rear wall 16 and is usually connected to suitable venting (not shown) that provides an exhaust path for the dryer heated air to leave the room where the dryer 10 is located.

It should be understood that the blower fan 48 creates a negative type pressure within the dryer cabinet by its operation during normal dryer use. By negative pressure it is meant that because the blower fan 48 is forcing air out of the exhaust duct 52 it is creating a negative pressure in the dryer cabinet which draws air from the ambient outside of the dryer into the dryer cabinet for circulation through the dryer drum 26. In order to have ambient air enter the cabinet 12 the dryer, as shown in FIG. 2, dryer 10 is provided with one or more louvres 70 and covers 72 which will be described in more detail hereinafter.

After the clothing articles have been dried, they may be removed from the drum 26 via the opening 32. Opening 32 is shown closed by a window or port-hole like door 60. Door 60 has a handle 62 for pivotally opening the door about hinge 64.

The dryer 10 is shown to have a control wall 54 with touch and or dial controls 56 that permit the user to control operation of dryer 10.

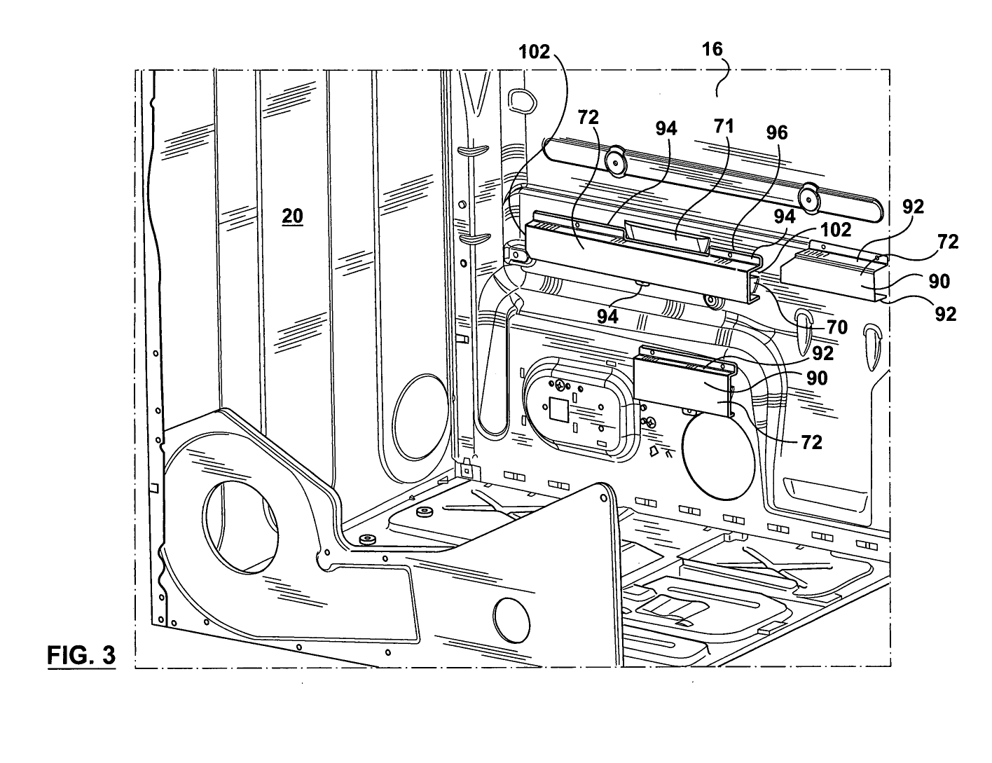

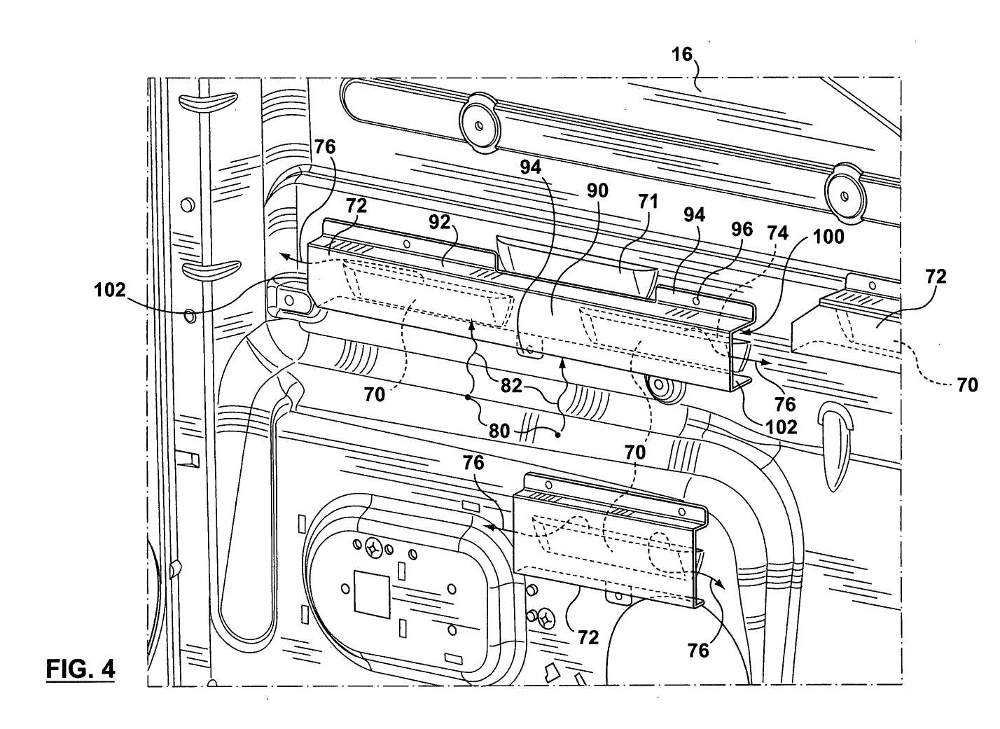

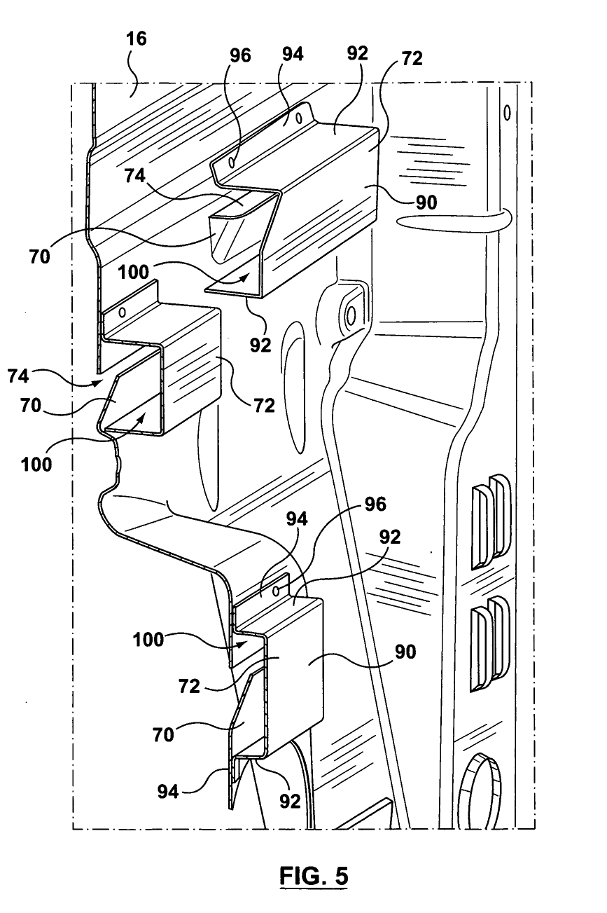

As shown in FIGS. 3 to 5, louvres 70 extend horizontally along the rear wall 16 and provide opening 74 in the rear wall through which ambient air may enter as shown by the airflow arrows 76 in FIG. 4. The airflow arrow 76 shows ambient air entering the dryer during normal dryer operation as a result of the operation of the blower fan 48 (FIG. 2).

As shown in FIGS. 3 to 5, covers 72 cover the louvres 70 by overlaying the louvres 70 in spaced relation therefrom. The covers 72 extend along the horizontal length of the louvres 70. In one embodiment, one cover 72 may cover more than one louvre or alternatively, one or more covers 72 may cover one louvre 70. The purpose of the cover 72 is to restrict flow of ignited particles 80 (FIG. 4) and other debris from leaving the dryer cabinet should a fire develop in the dryer. The airflow pattern of the rising ignited particles 80 is generally shown by arrows 82 to be generally upward. Such particles can also fall. However it should be understood that any changes in the current of the airflow may potentially result in the particles 82 moving through the openings 74 of the louvres 70 and exiting the dryer cabinet if the covers 72 are not present. Hence the covers guard against and restrict flow of particles 80, and other debris rising and falling within the cabinet, from exiting the cabinet 12 through the louvre 70.

In the embodiment shown, the covers 72 have a generally u-shaped cross-section provided by an end wall 90 with two side walls 92 that space the cover end wall 90 away from the rear wall 16 of the dryer cabinet 12. As a result, the covers 72 define with the rear wall 16 an airflow channel 100 which extends along the length of the louvre 70. The side walls 92 further have flanges 94 which lie flush with and are mounted to the cabinet rear wall 16 by suitable means such as screws (not shown) which pass through openings 96 in the flange 94 and into the rear wall 16 of the cabinet 12. The upper flanges 94 are elongate and co-extend, or at least partially co-extend, with the upper side wall 92 whereas the lower flange 94 is a button-like flange that extends out from the lower side wall 92 of the cover 72. The cover 72 preferably is made from steel, similar to the material for the rear wall 16 of the dryer 10. Alternatively, the cover 72 may comprise any suitable material that is resistant to fire.

The cover 72 effectively extends at least along the horizontal length of the louvre to define a horizontally extending airflow channel 100 that allows the ambient air 76 to flow out the horizontally opposed open ends portions 102, defined between an end portion of the cover 72 and the wall 16 of the cabinet, during normal dryer operation. The cover also guards against or restricts the flow of particles 80 from escaping out of the cabinet through the openings 74 in the louvres 70 due to any shifts in air current or rising and falling of the particles or debris. Clearly advantage is found with the covers 72 as they reduce the risk of fires spreading from the dryer cabinet by impeding the flow of ignited particles, and other debris, from passing through opening 74 in louvre 70.

Referring to FIGS. 3, 4 and 5, is can also be seen that the rear wall 16 of the cabinet is shown to include louvre 71 that is uncovered. Louvre 71 remains uncovered because, in the fully assembled dryer, the rear wall of the heater housing 22 (see FIG. 2), or diffuser wall, is very close to the rear wall 16 of the dryer cabinet and covers the louvre 71 whereby debris and ignited particles are restricted from flowing between the heater housing 22 and the rear wall 16.

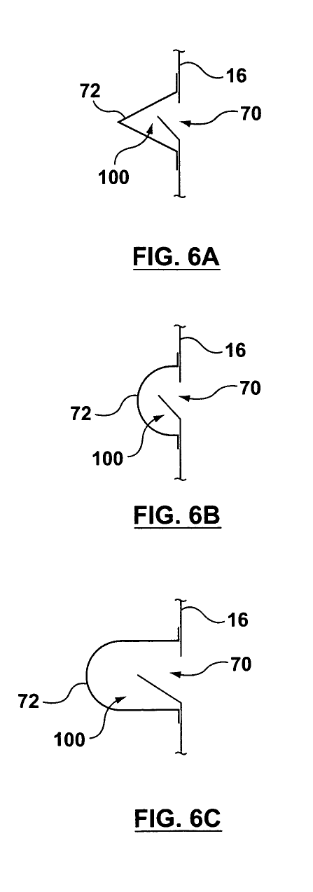

Referring to FIGS. 6A to 6C, the covers 70 are shown respectively to have a triangular V-shaped cross-sectional shape, a semi-circular cross-sectional shape, and a rounded u-shaped cross-sectional shape.

While the invention has been described in terms of various specific embodiments, those skilled in the art will recognize that the invention can be practiced with modifications within the scope of the present invention as disclosed herein.

What is claimed is:

1. A clothes dryer, comprising:
a cabinet having a wall;
a louvre located in the wall to allow ambient air to enter the cabinet; and,
a cover mounted inside the cabinet and mounted to the wall of the cabinet, the cover overlaying the louvre and spaced therefrom, and the cover extending along the louvre to define an air flow channel between the cover and the wall where the airflow channel has at least one opening between the wall and an end portion of the cover to permit air to flow into the cabinet through the louvre, along the air flow channel and out the at least one opening while restricting flow of ignited particles and debris from exiting through the louvre.

2. The clothes dryer of claim 1 wherein the wall is a rear wall for the cabinet.

3. The clothes dryer of claim 2 comprising a plurality of horizontally extending louvres located on the rear wall and a plurality of covers covering the louvres.

4. The clothes dryer of claim 3 wherein each of the covers comprises an elongated U-shaped bracket having an end wall spaced from the rear wall of the cabinet by side walls of the bracket extending from the rear wall of the cabinet, and the bracket defining with the rear wall horizontally opposing open end portions whereby air entering the cabinet through the louvre moves along the air flow channel and through the opposing open end portions into the cabinet.

5. The clothes dryer of claim 4 wherein each of the side walls of the brackets have flanges lying flush with and mounted to the rear wall of the cabinet.

6. The clothes dryer of claim 1 wherein the louvre has a length and the cover extends at least entirely along the length of the louvre.

7. The clothes dryer of claim 1 wherein the cover has one cross-sectional shape selected from the group consisting of a triangular V-shaped cross-sectional shape, a rounded u-shaped cross-sectional shape, a squared u-shaped cross-sectional shape, and a semi-circular cross-sectional shape.

8. A clothes dryer, comprising:
a cabinet having a wall;
a louvre located in the wall to allow ambient air to enter the cabinet; and,
a cover mounted inside the cabinet and mounted to the wall of the cabinet, the cover extending over the louvre to define an air flow channel that permits air to flow into the cabinet through the louvre and along the air flow channel while restricting flow of ignited particles and debris from exiting through the louvre.

9. The clothes dryer of claim 8 wherein the wall is a rear wall for the cabinet.

10. The clothes dryer of claim 9 comprising a plurality of horizontally extending louvres located on the rear wall and a plurality of covers covering the louvres.

11. The clothes dryer of claim 10 wherein each of the covers comprises an elongated U-shaped bracket having an end wall spaced from the rear wall of the cabinet by side walls of the bracket extending from the rear wall of the cabinet, and the bracket having horizontally opposing open end portions whereby air entering the cabinet through the louvre moves along the air flow channel and through the opposing open end portions into the cabinet.

12. The clothes dryer of claim 11 wherein each of the side walls of the brackets have flanges lying flush with and mounted to the rear wall of the cabinet.

13. The clothes dryer of claim 8 wherein the louvre has a length and the cover extends at least entirely along the length of the louvre.

14. The clothes dryer of claim 8 wherein the cover has one cross-sectional shape selected from the group consisting of a triangular V-shaped cross-sectional shape, a rounded u-shaped cross-sectional shape, a squared u-shaped cross-sectional shape, and a semi-circular cross-sectional shape.
